(19) United States
(12) Patent Application Publication
(10) Pub. No.: US 2020/0141441 A1
(43) Pub. Date: May 7, 2020

(54) PRESSING-TYPE SCREW

(71) Applicant: Yi-Chang WU, Taoyuan City (TW)

(72) Inventor: Yi-Chang WU, Taoyuan City (TW)

(21) Appl. No.: 16/224,840

(22) Filed: Dec. 19, 2018

(30) Foreign Application Priority Data
Nov. 2, 2018 (CN) 201811300362.7

(51) Int. Cl. F16B 35/06; F16B 35/04; F16B 25/00

(52) U.S. Cl. CPC F16B 35/06; F16B 25/0042; F16B 35/041

(57) ABSTRACT

A pressing-type screw includes a screw-head component, a shank member, a multi-piece member, and a drilling-head component. The screw-head component is provided with a fastening slot, and is located at top of the shank member. The multi-piece member is located surrounding the shank member, where every single-piece member of the multi-piece member, if cross-sectioned, includes a consecutively formed first surface and second surface, and where the single-piece members of the multi-piece member, in a longitudinal direction of the shank member, each have their first surfaces parallel with each other. The drilling-head component is located at bottom of the shank member. As such, the pressing-type screw utilizes a pressing-and-securing manner to simplify the securing process in use of screws, such that the working efficiency thereof can be improved effectively.

### BACKGROUND OF THE INVENTION

### 1. Field of the Invention

The present invention relates to a pressing-type screw, and more particularly, to a structural design by forming a multi-piece member on a shank member of the screw, so as to achieve the purpose of speedily securing the screw on an object in a pressing-type fixing manner.

### 2. Description of Related Art

Various fasteners are employed in the industrial design or interior design, as fixing components, for joining different objects. Namely, holes are drilled at two overlapped objects, and fasteners are used to fasten the same together. The fasteners may include rivets, nails, screws, and so forth, all relating to mechanical fixing manners.

It is noted that rivets relate to a destructive fixing measure, such that after the objects are fixed, the rivets or the objects are required to be destructed in order to detach the rivets from the objects. Whereas in spite of the fact that the nails and the screws relate to a nondestructive fixing measure, extra tools are necessary for anchoring the nails or the screws into the objects, or otherwise removing the same from the objects.

The nails relate to a structure formed with a sharp point, such that a user applies an external force to insert the nails into the objects so as to produce a frictional force to fix together the objects. In comparison, the screw makes use of the structure formed with an external thread to be engaged with the object so as to fix the same together. Such a screw-fastening effect is much firmer than the fastening effect of a nail. Nevertheless, in the use of the screw to perform an object-fixing work, a screwdriver is required for tightening or loosening the screw, and as a result, time and effort consumptions are necessary.

Given the above, with a spirit of aggressive innovation, a “Pressing-Type Screw” is conceptualized, such that in a structural design a multi-piece member is formed on a shank member of the screw, so as to allow the screw to be pressed and fastened into a hole of the object without the use of a screwdriver, though the screwdriver is necessary only when the pressing-type screw is to be screwed-off and removed. Through such a simplified screw installation process, working efficiency can be increased effectively. As such, with persistent research and experiments, a “Pressing-Type Screw” can be accomplished eventually.

### SUMMARY OF THE INVENTION

To solve the problem given above, an object of the present invention is to provide a pressing-type screw, by using a structural design with a multi-piece member formed on a shank member of the screw, so as to allow the screw to be pressed and fastened into an object, where a screw-installation process can be simplified and the working efficiency can be increased effectively.

To achieve the above-mentioned object, the pressing-type screw, according to the present invention, comprises a screw-head component, a shank member, a multi-piece member, and a drilling-head component. The screw-head component is provided with a fastening slot, and is located at top of the shank member. The multi-piece member is located surrounding the shank member, where every single-piece member of the multi-piece member, if cross-sectioned, includes a consecutively formed first surface and second surface, where the single-piece members of the multi-piece member, in a longitudinal direction of the shank member, each have their first surfaces parallel with each other. The drilling-head component is located at bottom of the shank member.

According to the present invention, every two single-piece members of the multi-piece member are located at the same levels along the longitudinal direction of the shank member, and are symmetrically formed as two semicircles around the shank member.

Further, according to the present invention, a plurality of the single-piece members of the multi-piece member are located at the same levels along the longitudinal direction of the shank member, and are formed as multiple equally-divided-rounds around the shank member such as three one-third rounds or four one-fourth rounds.

Still further, according to the present invention, in the longitudinal direction of the shank member, the second surface of a single-piece member of the multi-piece member is formed an included angle, with the first surface thereof, between 30 to 50 degrees.

According to the present invention, in the longitudinal direction of the shank member, neighboring single-piece members of the multi-piece member relate to a consecutively-formed structure.

Further, according to the present invention, the single-piece members of the multi-piece member are each provided with a recess surrounding the shank member and opening at the first surface.

Still further, according to the present invention, the screw-head component, the shank member, the multi-piece member, and the drilling-head member relate to an integral structure.

According to the present invention, the screw-head component, the shank member, the multi-piece member, and the drilling-head member are made of plastic material.

Further, according to the present invention, the multi-piece member is made of nylon.

Still further, according to the present invention, the fastening slot may either be a cross-like slot, a “-”-like slot, a hexagonal slot, or a star-like slot.

The abovementioned brief description and the following detailed description are for the purpose of exemplification, and for a further explanation of the claims, and that it is understood that other objects, advantages, and novel features of the present invention will become more apparent from the following description when taken in conjunction with the accompanying drawings.

### BRIEF DESCRIPTION OF THE DRAWINGS

FIG. 1 is a perspective view illustrating a pressing-type screw according to the present invention;

FIG. 2 is another perspective view illustrating the pressing-type screw according to the present invention;

FIG. 3A is a side view illustrating the pressing-type screw according to the present invention;

FIG. 3B is another side view illustrating the pressing-type screw according to the present invention;

FIG. 3C is a cross-sectional view taken along cutting line A-A of FIG. 3B;

FIG. 4 is a cross-sectional view illustrating the pressing-type screw, according to the present invention, to be engaged with an object; and

FIG. 5 is a cross-sectional view illustrating the pressing-type screw, according to the present invention, engaged with the object.

### DETAILED DESCRIPTION OF THE PREFERRED EMBODIMENTS

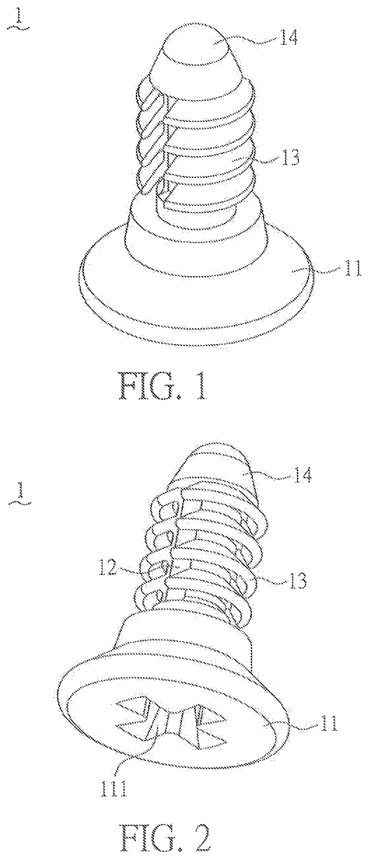

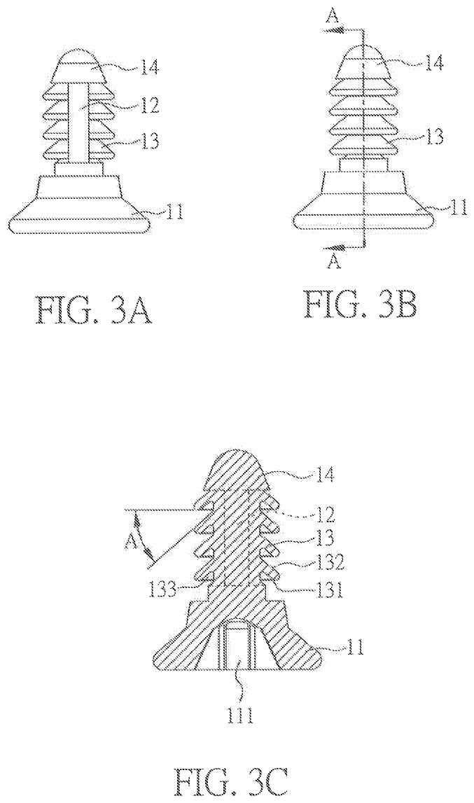

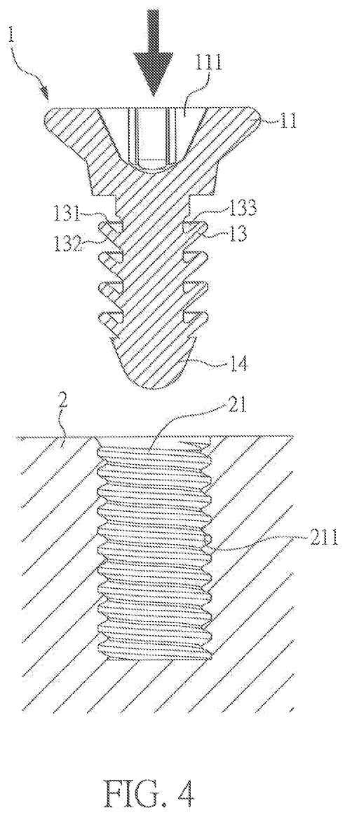

References are made to FIG. 1, a perspective view illustrating a pressing-type screw according to the present invention; FIG. 2, another perspective view illustrating the pressing-type screw; FIG. 3A, a side view illustrating the pressing-type screw; FIG. 3B, another side view illustrating the pressing-type screw; and FIG. 3C, a cross-sectional view taken along cutting line A-A of FIG. 3B. The pressing-type screw 1 comprises a screw-head component 11, a shank member 12, an octo-piece member 13, and a drilling-head component 14.

According to the present invention, the screw-head component 11 is provided with a fastening slot 111, and is located at top of the shank member 12. The octo-piece member 13 is located surrounding the shank member 12, where every single-piece member of the octo-piece member 13 includes a first surface 131, a second surface 132, and a recess 133. The single-piece members of the octo-piece member 13, in a longitudinal direction of the shank member 12, each have their first surfaces 131 parallel with each other. The drilling-head component 14 is located at bottom of the shank member 12.

As shown in FIG. 1 to FIG. 3C, every two single-piece members of the octo-piece member 13 are located at the same levels along the longitudinal direction of the shank member 12, and are symmetrically and respectively formed as two semicircles around the shank member 12. Each single-piece member of the octo-piece member 13, if cross-sectioned, includes the consecutively formed first surface 131 and second surface 132, whereas the recess 133 surrounds the shank member 12 and opens at the first surface 131, such that the recess 133 makes each single-piece member of the octo-piece member 13 open through circumferentially around the shank member 12.

Further, according to the present invention, in the longitudinal direction of the shank member 12, neighboring single-piece members of the octo-piece member 13 relate to a consecutively-formed structure, where the second surface 132 of a single-piece member of the octo-piece member 13 is formed an included angle A with the first surface 131 thereof, and where the included angle is between 30 to 50 degrees, preferably 40 degrees. Still further, according to the present invention, the screw-head component 11, the shank member 12, the octo-piece member 13, and the drilling-head member 14 relate to an integral structure, and are made of plastic material, wherein the octo-piece member 13 is preferably made of nylon.

As shown in FIG. 3C, the second surface 132 of a single-piece member of the octo-piece member 13 relates to an inclined surface, so that the pressing-type screw 1 can be pushed easily into the hole of an object. In compliance with the structural design of the recess 133, an end turning from the first surface 131 to the second surface 132 can be bent and deformed. Suppose the octo-piece member 13 is subject to a force, the recesses 133 can provide a sufficient space of deformation for the octo-piece member 13, making the pressing-type screw 1 able to respond to the dimension of the hole of the object more resiliently. As such, the pressing-type screw 1 can perform a fixing work by way of the deformation of the octo-piece member 13.

According to the present invention, in spite of the fact that every two single-piece members of the octo-piece member 13 are located at the same levels along the longitudinal direction of the shank member 12, and are symmetrically and respectively formed as two semicircles around the shank member 12, as mentioned above, a structure of multiple three one-third rounds or four one-fourth rounds around the shank member 12 may be possible. Also, as mentioned above, the second surface 132 of a single-piece member of the octo-piece member 13 is formed an included angle A with the first surface 131 of a neighboring single-piece member of the octo-piece member 13. However, the included angle A can be adjusted in accordance with the dimension of the hole of the object and with the pitch of the thread in the hole. In addition, the number of the single-piece member of the octo-piece member 13 is not limited to eight, but rather, the number of the single-piece member and the dimension of the included angle A may comply with actual needs.

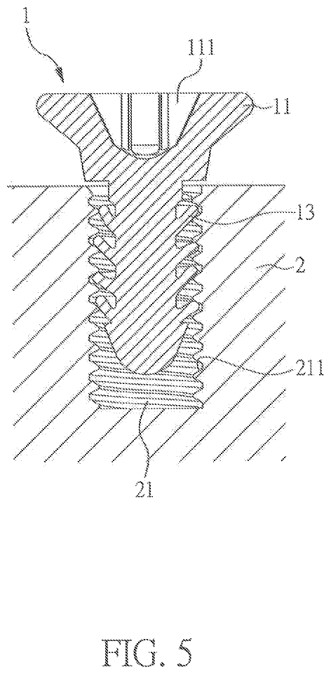

Now references are made to FIG. 4, a cross-sectional view illustrating the pressing-type screw, according to the present invention, to be engaged with an object; and FIG. 5, a cross-sectional view illustrating the pressing-type screw engaged with the object.

As shown in FIG. 4, the object 2 is provided with a mounting hole 21 which is formed inside with a thread portion 211. When a user intends to secure the pressing-type screw 1 to the object 2, he/she only needs to align the drilling-head component 14 with the mounting hole 21, and exerts downward a force toward the screw-head component 11, then the pressing-type screw 1 can be secured into the mounting hole 21.

Further, according to the present invention, upon exerting a force downward and pushing the pressing-type screw 1 into the mounting hole 21, the structural design of the octo-piece member 13, and of the recess 133, are used, such that every single-piece member of the octo-piece member 13 is squeezed, bent, and deformed, in response to the structure of the thread portion 211, and that every single-piece member of the octo-piece member 13 can be engaged smoothly with and in the thread portion 211.

Still further, according to the present invention, the screw-head component 11, the shank member 12, the octo-piece member 13, and the drilling-head component 14 each relates to a structure made of plastic material. This not only facilitates the pressing-type screw 1 engaging easily with the object 2 made of plastics or wood, but also in case of the engagement of the octo-piece member 13 and the thread portion 211, the plastic material of the octo-piece member 13 can, upon bending and deformation of the structure thereof, produce an elastic restoring force. This elastic restoring force occurs at where every single-piece member of the octo-piece member 13 is engaged with the thread portion 211, so as to strengthen the securing force of the pressing-type screw 1. Finally, in case the pressing-type screw 1 is to be removed, a screwdriver (not shown) can be used to insert into the fastening slot 111 so as to unscrew and remove the pressing-type screw 1.

It should be noted that, according to the present invention, it is not intended to limit the mounting hole 21 to be provided with the thread portion 211 for being engaged with the pressing-type screw 1. In other words, a mounting hole without the thread portion, or a hole passing through the object, can also be applied to the pressing-type screw 1. Namely, any hole formed in the object can be employed for a securing work by using the pressing-type screw 1. Nor the fastening slot 111 is to be limited to a structure having a cross-like slot, a “-”-like slot, a hexagonal slot, or a star-like slot, but primarily for satisfying an actual need.

Given the above, the pressing-type screw 1 utilizes the octo-piece member 13 and the recesses 133 to perform the securing work, together with the feature that the octo-piece member 13 is made of plastic material, making the pressing-type screw 1 conform flexibly to the dimension of the hole of the object, such that the elastic restoring force incurred can help reinforce a securing effect. Such pressing-type securing manner simplifies the securing process in use of screws for securing multiple objects, and in the meantime, the working efficiency can be improved effectively.

Although the present invention has been explained in relation to its preferred embodiments, it is to be understood that many other possible modifications and variations can be made without departing from the scope of the invention as hereinafter claimed.

What is claimed is:

1. A pressing-type screw, comprising:
a screw-head component, provided with a fastening slot;
a shank member, with the screw-head component located at top of the shank member;
a multi-piece member, located surrounding the shank member, and every single-piece member of the multi-piece member, if cross-sectioned, including a consecutively formed first surface and second surface, wherein the single-piece members of the multi-piece member, in a longitudinal direction of the shank member, each have their first surfaces parallel with each other; and
a drilling-head component, located at bottom of the shank member.

2. The pressing-type screw as claimed in claim 1, wherein the every single-piece member of the multi-piece member is provided with a recess surrounding the shank member and opening at the first surface.

3. The pressing-type screw as claimed in claim 1, wherein every two single-piece members of the multi-piece member are located at the same levels along the longitudinal direction of the shank member, and are symmetrically formed as two semicircles around the shank member.

4. The pressing-type screw as claimed in claim 1, wherein in the longitudinal direction of the shank member, the second surface of a single-piece member of the multi-piece member is formed an included angle, with the first surface thereof, between 30 to 50 degrees.

5. The pressing-type screw as claimed in claim 1, wherein in the longitudinal direction of the shank member, neighboring single-piece members of the multi-piece member relate to a consecutively-formed structure.

6. The pressing-type screw as claimed in claim 1, wherein the screw-head component, the shank member, the multi-piece member, and the drilling-head member relate to an integral structure.

7. The pressing-type screw as claimed in claim 1, wherein the screw-head component, the shank member, the multi-piece member, and the drilling-head member are made of plastic material.

8. The pressing-type screw as claimed in claim 1, wherein the multi-piece member is made of nylon.

9. The pressing-type screw as claimed in claim 1, wherein the fastening slot is either a cross-like slot, a “-”-like slot, a hexagonal slot, or a star-like slot.
